(19) United States
(12) Patent Application Publication
(10) Pub. No.: US 2020/0015254 A1
(43) Pub. Date: Jan. 9, 2020

(54) WIRELESS COMMUNICATION SYSTEM, CONTROL APPARATUS, BASE STATION, TERMINAL DEVICE, CONTROL METHOD, AND STORAGE MEDIUM

(71) Applicant: NEC Corporation, Tokyo (JP)

(72) Inventor: Taketoshi NAKAJIMA, Tokyo (JP)

(73) Assignee: NEC Corporation, Tokyo (JP)

(21) Appl. No.: 16/494,154

(22) PCT Filed: Mar. 22, 2018
(86) PCT No.: PCT/JP2018/011495

§ 371 Date: Sep. 13, 2019

(30) Foreign Application Priority Data
Mar. 23, 2017 (JP) 2017-057127

(51) Int. Cl. H04W 72/12

(52) U.S. Cl. CPC H04W 72/1263; H04W 72/1247; H04W 72/1289

(57) ABSTRACT

A wireless communication system according to one example embodiment of the present invention includes a plurality of base stations and a plurality of terminal devices capable of performing wireless communication by using a plurality of wireless communication schemes that share the same frequency band and further includes a control apparatus that, in each of a plurality of predefined periods, determines a wireless communication scheme permitted for wireless communication and causes the terminal devices to perform only wireless communication based on the determined wireless communication scheme during the periods.

### TECHNICAL FIELD

The present invention relates to a wireless communication system, a control apparatus, a base station, terminal device, a control method, and a storage medium.

### BACKGROUND ART

In recent years, wireless Local Area Network (LAN) has been widely used, various communication standards or communication schemes have been proposed. For example, Patent Literature 1 discloses a plurality of wireless systems that share the same frequency. This wireless system specifies a Network Allocation Vector (NAV) period by using a reservation signal from a terminal device or a base station and prohibits transmission from other terminal devices or base stations.

### CITATION LIST

### Patent Literature

PTL 1: Japanese Patent Application Laid-Open No. 2014-82567

### SUMMARY OF INVENTION

### Technical Problem

In the wireless communication system disclosed in Patent Literature 1, however, it is necessary to set a NAV period in accordance with a Request to Send (RTS) frame or a Clear to Send (CTS) frame. That is, since no NAV period is determined in advance, a terminal device and a base station need to monitor the NAV period that may vary. Further, in a wireless communication scheme having neither RTS frame nor CTS frame, since it is not possible to set a NAV period, it may be difficult to perform smooth wireless communication.

The present invention has been made in view of the above problems and intends to provide a wireless communication system that can perform smooth wireless communication in different wireless communication schemes.

### Solution to Problem

According to one example aspect of the present invention, provided is a wireless communication system including a plurality of base stations and a plurality of terminal devices capable of performing wireless communication by using a plurality of wireless communication schemes that share the same frequency band, and the wireless communication system further includes: a control apparatus that, in each of a plurality of predefined periods, determines a wireless communication scheme permitted for wireless communication and causes each of the terminal devices to perform only wireless communication based on the determined wireless communication scheme during the periods.

According to another example aspect of the present invention, provided is a control apparatus that controls a plurality of base stations and a plurality of terminal devices capable of performing wireless communication by using a plurality of wireless communication schemes that share the same frequency band, and in each of a plurality of predefined periods, the control apparatus determines a wireless communication scheme permitted for wireless communication and causes each of the terminal devices to perform only wireless communication based on the determined wireless communication scheme during the periods.

According to another example aspect of the present invention, provided is a base station used in a wireless communication system including a plurality of terminal devices and a plurality of base stations capable of performing wireless communication by using a plurality of wireless communication schemes that share the same frequency band and a control apparatus, and in each of a plurality of predefined periods, a wireless communication scheme permitted for wireless communication is determined, and signals that cause each of the terminal devices to perform only wireless communication based on the determined wireless communication scheme during the periods are transmitted from the control apparatus to the plurality of terminal devices.

According to another example aspect of the present invention, provided is a terminal device used in a wireless communication system including a plurality of base stations and a plurality of terminal devices capable of performing wireless communication by using a plurality of wireless communication schemes that share the same frequency band and a control apparatus, and in each of a plurality of predefined periods, a wireless communication scheme permitted for wireless communication is determined, and the terminal device is controlled based on a signal that causes the terminal device to perform only wireless communication based on the determined wireless communication scheme during the periods.

According to another example aspect of the present invention, provided is a control method of a control apparatus that controls a plurality of base stations and a plurality of terminal devices capable of performing wireless communication by using a plurality of wireless communication schemes that share the same frequency band, and the control method includes a step of: in each of a plurality of predefined periods, determining a wireless communication scheme permitted for wireless communication and causing each of the terminal devices to perform only wireless communication based on the determined wireless communication scheme during the periods.

According to another example aspect of the present invention, provided is a control method of a base station used in a wireless communication system including a plurality of terminal devices and a plurality of base stations capable of performing wireless communication by using a plurality of wireless communication schemes that share the same frequency band and a control apparatus, and the control method includes a step of: in each of a plurality of predefined periods, determining a wireless communication scheme permitted for wireless communication and transmitting, from the control apparatus to the plurality of terminal devices, signals that cause each of the terminal devices to perform only wireless communication based on the determined wireless communication scheme during the periods.

According to another example aspect of the present invention, provided is a control method of a terminal device used in a wireless communication system including a plurality of base stations and a plurality of terminal devices capable of performing wireless communication by using a plurality of wireless communication schemes that share the same frequency band and a control apparatus, and the control method includes a step of: in each of a plurality of predefined periods, determining a wireless communication scheme permitted for wireless communication and controlling the terminal device based on a signal that causes the terminal device to perform only wireless communication based on the determined wireless communication scheme during the periods.

According to another example aspect of the present invention, provided is a storage medium storing a program that causes a computer to perform a control method of a control apparatus that controls a plurality of base stations and a plurality of terminal devices capable of performing wireless communication by using a plurality of wireless communication schemes that share the same frequency band, and the control method includes a step of: in each of a plurality of predefined periods, determining a wireless communication scheme permitted for wireless communication and causing each of the terminal devices to perform only wireless communication based on the determined wireless communication scheme during the periods.

According to another example aspect of the present invention, provided is a storage medium storing a program that causes a computer to perform a control method of a base station used in a wireless communication system including a plurality of terminal devices and a plurality of base stations capable of performing wireless communication by using a plurality of wireless communication schemes that share the same frequency band and a control apparatus, and the control method includes a step of: in each of a plurality of predefined periods, determining a wireless communication scheme permitted for wireless communication and transmitting, from the control apparatus to the plurality of terminal devices, signals that cause the terminal devices to perform only wireless communication based on the determined wireless communication scheme during the periods.

According to another example aspect of the present invention, provided is a storage medium storing a program that causes a computer to perform a control method of a terminal device used in a wireless communication system including a plurality of base stations and a plurality of terminal devices capable of performing wireless communication by using a plurality of wireless communication schemes that share the same frequency band and a control apparatus, and the control method includes a step of: in each of a plurality of predefined periods, determining a wireless communication scheme permitted for wireless communication and controlling the terminal device based on a signal that causes the terminal device to perform only wireless communication based on the determined wireless communication scheme during the periods.

### Advantageous Effects of Invention

According to the present invention, it is possible to perform smooth wireless communication in a wireless communication system using different wireless communication schemes.

### BRIEF DESCRIPTION OF DRAWINGS

FIG. 1 is a block diagram of a wireless communication system in a first example embodiment.

FIG. 2 is a block diagram of a control apparatus in the first example embodiment.

FIG. 3 is a block diagram of a base station in the first example embodiment.

FIG. 4 is a block diagram of a terminal device in the first example embodiment.

FIG. 5 is a diagram illustrating one example of channels of the wireless communication in the first example embodiment.

FIG. 6 is a diagram illustrating one example of a frame of the wireless communication in the first example embodiment.

FIG. 7 is a conceptual diagram of a wireless communication method in the first example embodiment.

FIG. 8 is a diagram illustrating one example of schedule information in the first example embodiment.

FIG. 9 is a flowchart illustrating an operation of the control apparatus in the first example embodiment.

FIG. 10 is a sequence chart of the wireless communication system in the first example embodiment.

FIG. 11 is a sequence chart of the wireless communication system in the first example embodiment.

FIG. 12 is a diagram illustrating one example of schedule information in a second example embodiment.

FIG. 13 is a diagram illustrating one example of schedule information in a third example embodiment.

FIG. 14 is a diagram illustrating one example of schedule information in a fourth example embodiment.

FIG. 15 is a schematic configuration diagram of a wireless communication system in a sixth example embodiment.

### DESCRIPTION OF EMBODIMENTS

Example embodiments of the present invention will be described below with reference to the drawings.

### First Example Embodiment

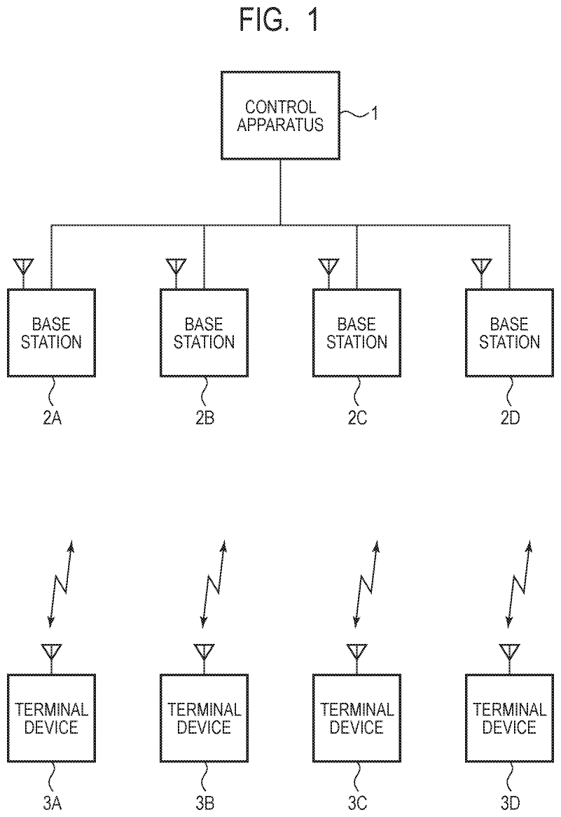

FIG. 1 is a block diagram of a wireless communication system in the present example embodiment. The wireless communication system includes a control apparatus 1, a plurality of base stations 2A to 2D, and a plurality of terminal devices 3A to 3D, and communication according to a plurality of different wireless LAN standards can be performed. The control apparatus 1 may be a server computer or a cloud server, for example, and controls the plurality of base stations 2A to 2D. The base stations 2A to 2D are access points or edge computers that perform wireless communication according to wireless LAN standards different from each other, respectively. Here, a plurality of wireless LAN standards may include, for example, Wi-Fi (registered trademark) communication scheme defined by Institute of Electrician and Electronics Engineers (IEEE) 802.11b, IEEE 802.11g, IEEE 802.11n, or the like, Bluetooth Low Energy (BLE) (registered trademark) communication scheme defined by IEEE 802.15.1, ZigBee (registered trademark) communication scheme defined by IEEE 802.15.4, or the like. In the following description, the base station 2A performs wireless communication by using the Wi-Fi communication scheme of IEEE 802.11b, and the base station 2B performs wireless communication by using the Wi-Fi communication scheme of IEEE 802.11n. Further, the base station 2C performs wireless communication by using the BLE communication scheme of IEEE 802.15.1, and the base station 2D performs wireless communication by using the ZigBee communication scheme of IEEE 802.15.4. Each of the terminal devices 3A to 3D is a computer, a mobile terminal, an embedded device, or the like and wirelessly communicates with the corresponding base stations 2A to 2D. While FIG. 1 illustrates the base stations 2A to 2D and the terminal devices 3A to 3D using four types of wireless communication schemes, the wireless communication system may include base stations or terminal devices using other wireless communication schemes. Further, the wireless communication system may include a plurality of terminal devices that can wirelessly communicate with one base station.

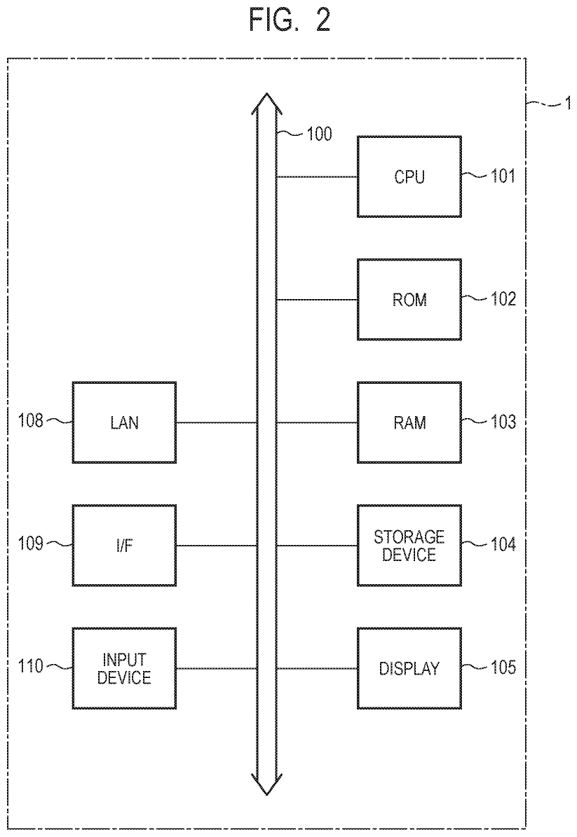

FIG. 2 is a block diagram of the control apparatus in the present example embodiment. The control apparatus 1 includes a bus 100, a CPU 101, a read only memory (ROM) 102, a random access memory (RAM) 103, a storage device 104, a display 105, a LAN unit 108, an interface (I/F) 109, and an input device 110.

The CPU 101 controls the base station 2 and the terminal device 3 in accordance with an application program and schedule information. As described later, schedule information defines a communication scheme permitted for wireless communication during a predetermined band guarantee period. Schedule information may be determined by a request from the terminal device 3 or may be input from an external device. The ROM 102 is formed of a non-volatile memory and stores an application program. An application program may be downloaded from a server via a network. The RAM 103 provides a memory field required for the operation of the CPU 101. The storage device 104 is a massive storage device such as a hard disk. The display 105 is formed of a liquid crystal display device and may display schedule information and the operation status of the base station 2. The LAN 108 is a wired communication interface based on the Ethernet (registered trademark) standard, for example, and is connected to the base stations 2A to 2D via communication cables. The input device 110 is a keyboard, a mouse, a touchscreen, or the like and is used for operating the control apparatus 1.

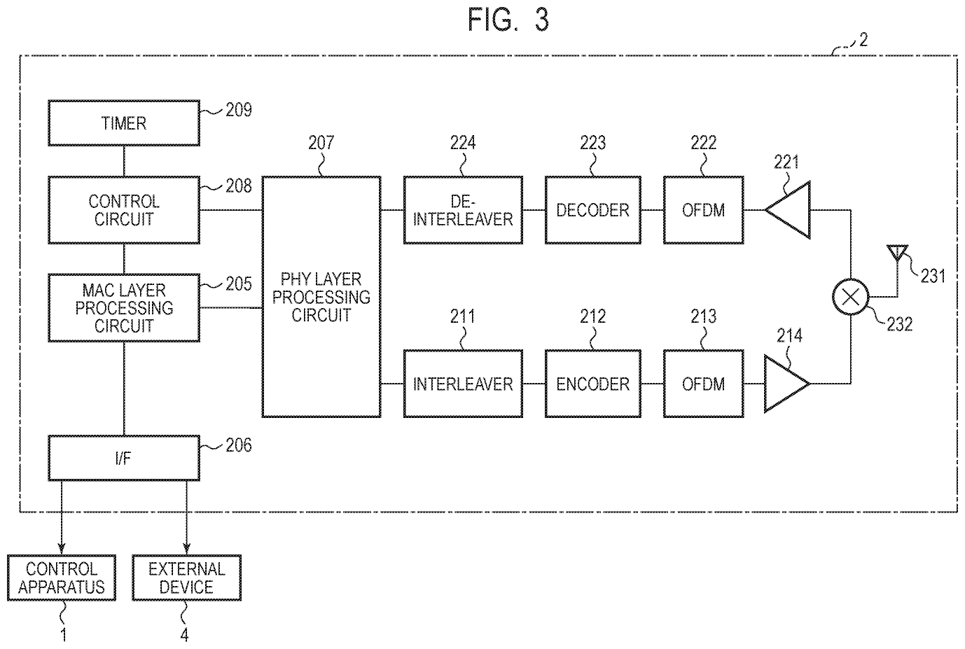

FIG. 3 is a block diagram of the base station 2 in the present example embodiment. Here, a circuit configuration based on the Wi-Fi communication scheme is described as an example. The base station 2 includes a Media Access Control (MAC) layer processing circuit 205, an I/F 206, a physical (PHY) layer processing circuit 207, a control circuit 208, a timer 209, an interleaver 211, an encoder 212, an Orthogonal Frequency Division Multiplexing (OFDM) circuit 213, a transmission frontend 214, a reception frontend 221, an OFDM circuit 222, a decoder 223, a de-interleaver 224, an antenna array 231, and a duplexer 232.

The MAC layer processing circuit 205 performs exchange of packet data with respect to an upper layer such as the application layer. The MAC layer processing circuit 205 receives packet data from the external device 4 via the I/F 206 and generates a MAC frame obtained by adding a MAC header and a Frame Check Sequence (FCS) to the packet data. The MAC header includes information on frame control, a period, an destination address, a source address, and a sequence control.

The PHY layer processing circuit 207 generates a physical layer data frame by adding a Physical Layer Convergence Procedure (PLCP) preamble and a PLCP header to the MAC frame output from the MAC layer processing circuit 205. Further, the PHY layer processing circuit 207 converts a frame from the antenna array 231 and the reception circuit into a MAC frame and outputs the MAC frame to the MAC layer processing circuit 205. The control circuit 208 controls the entire operation of the base station 2 including the MAC layer processing circuit 205 and the PHY layer processing circuit 207. The control circuit 208 receives schedule information and a time synchronization signal from the control apparatus 1 via the I/F 206 and controls transmission and reception in accordance with the schedule information. The timer 209 has an oscillator circuit and a counter and calibrates the counter based on the time synchronization signal.

The interleaver 211, the encoder 212, the OFDM circuit 213, and the transmission frontend 214 form a transmission circuit. The interleaver 211 rearranges bits of data frame output from the PHY layer processing circuit 207, the encoder 212 modulates the interleaved data frame with Binary Phase Shift Keying (BPSK) and generates OFDM symbols. The OFDM circuit 213 includes inverse fast Fourier transform (IFFT) circuit, a digital bit forming (DBF) circuit, and a space-time block coding (STBC) circuit and maps OFDM symbols to orthogonal subcarriers. The IFFT circuit converts a frequency domain signal into a time domain signal. THE DBF circuit performs processing so that a signal transmitted by the antenna array 231 has directivity. The STBC circuit calculates a time-space block coded signal and changes a space stream signal into a time stream signal. The transmission frontend 214 includes an up-converter, an intermediate frequency filter, and a power amplifier and outputs a signal having a carrier frequency in the 2.4 GHz band, for example. The duplexer 232 has a switch circuit and causes the transmission frontend 214 or the reception frontend 221 to selectively connect to the antenna array 231. The antenna array 231 includes a plurality of antennae and is able to improve a communication rate by using Multiple Input Multiple Output (MIMO) technology.

The reception frontend 221, the decoder 223, and the de-interleaver 224 form a reception circuit. A signal received by the antenna array 231 is output to the reception frontend 221 via the duplexer 232. The reception frontend 221 includes an amplifier circuit of a received signal and a detection circuit of a subcarrier. The OFDM circuit 222 includes a fast Fourier transform (FFT) circuit, a digital beam forming (DBF) circuit, and a space-time block coding (STBC) circuit. The FFT circuit converts a received time domain signal into a frequency domain signal. The DBF circuit extracts a received radio wave from noise and the like by performing processing in accordance with directivity. The STBC circuit calculates a time space block coded signal and obtains a diversity gain. The decoder 223 demodulates a BPSK-modulated signal and generates a binary sequence signal. The de-interleaver 224 decodes an interleaved bit sequence and outputs the decoded interleaved bit sequence to the PHY layer processing circuit 207. The PHY layer processing circuit 207 converts a physical layer frame into an MPDU frame and outputs the converted MPDU frame to the MAC layer processing circuit 205. The MAC layer processing circuit 205 extracts packet data from the MPDU frame and outputs the extracted packet data to the external device 4 via the I/F 206.

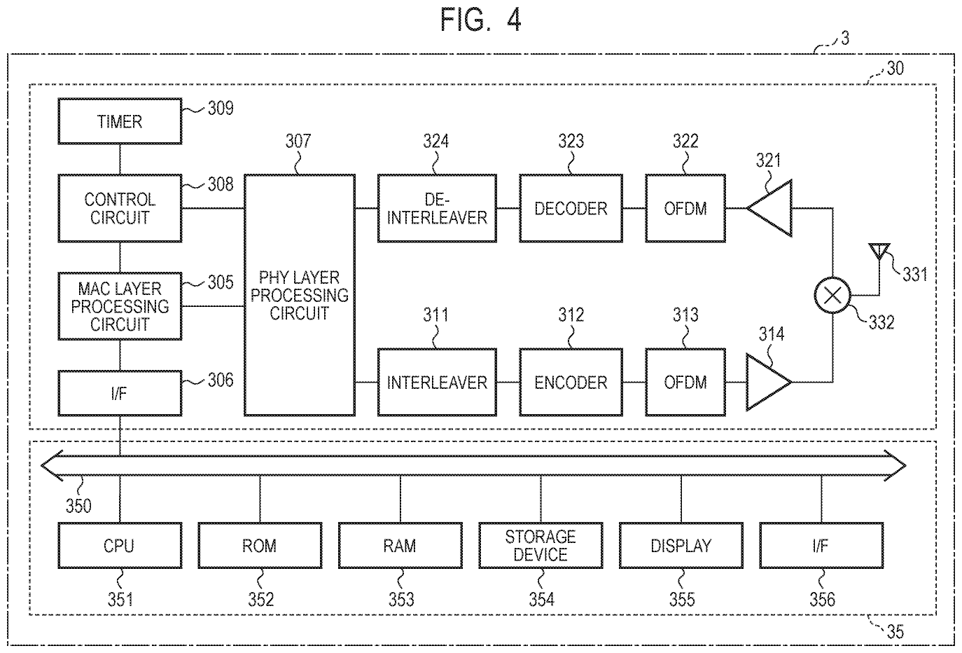

FIG. 4 is a block diagram of the terminal device 3. Here, a circuit configuration based on the Wi-Fi communication scheme is described as an example. The terminal device 3 has a wireless communication unit 30 and a computer unit 35. The wireless communication unit 30 includes a MAC layer processing circuit 305, an I/F 306, a PHY layer processing circuit 307, a control circuit 308, a timer 309, an interleaver 311, an encoder 312, an OFDM circuit 313, a transmission frontend 314, a reception frontend 321, an OFDM circuit 322, a decoder 323, a de-interleaver 324, an antenna array 331, and a duplexer 332. Since the configuration of the wireless communication unit 30 is the same as that of the base station 2, the detailed description thereof will be omitted. The computer unit 35 has a bus 350, a CPU 351, a ROM 352, a RAM 353, a storage device 354, a display 355, and an I/F 356. The computer unit 35 can perform processing in accordance with a predetermined application program by transmitting and receiving data to and from the base station 2 through the wireless communication unit 30. The computer unit 35 may be a general purpose computer or otherwise may be a robot control apparatus in a factory, an image capture apparatus, or the like. In particular, in a robot control apparatus in a factory, since real-time processing is required, delay in wireless communication may be a problem. According to the present example embodiment, it is possible to avoid the above problem by transmitting a data frame having high priority during a band guarantee period.

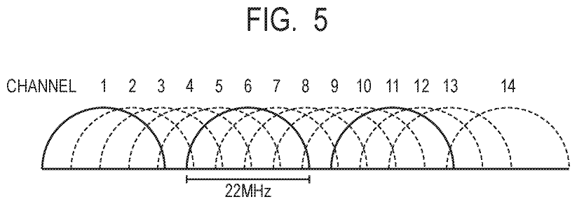

FIG. 5 illustrates radio channels of the 2.4 GHz band according to the Wi-Fi communication scheme as an example of wireless communication channel in the present example embodiment. The 2.4 GHz band has been used in various application such as industrial application, science application, medical application, a high-frequency energy source, or the like as a part of Industry Science Medical (ISM) frequency band. The 2.4 GHz band is divided into 14 channels each for 5 MHz from the first channel of the center frequency of 2.412 GHz. The bandwidth per channel is 22 MHz, and the first channel, the sixth channel, and the eleventh channel do not overlap each other, for example. While each channel bandwidth illustrated in FIG. 5 is 22 MHz, channels each having a bandwidth of 5 MHz or 10 MHz may be used. Since the 2.4 GHz band is used in the Wi-Fi communication scheme, the BLE communication scheme, and the ZigBee communication scheme, collision of wireless communication may occur. While transmission can be prohibited by defining a NAV period in the Wi-Fi communication scheme of IEEE 802.11b, IEEE 802.11g, IEEE 802.11n, and the like, a NAV period cannot be defined in the BLE communication scheme defined by the IEEE 802.15.1 and the ZigBee communication scheme defined by IEEE 802.15.4. Thus, the communication system of the present example embodiment avoids collision of communication by defining a plurality of band guarantee period in advance and defining a communication scheme permitted for wireless communication during respective band guarantee periods. Note that permission and prohibition of wireless communication may be defined over the entire 2.4 GHz band, and permission and prohibition of communication in the 2.4 GHz band may be defined for each of three groups of the first to fifth channels, the sixth to tenth channels, and the eleventh to fourteenth channels, for example. Furthermore, the present example embodiment may be applied in a band other than the ISM frequency band.

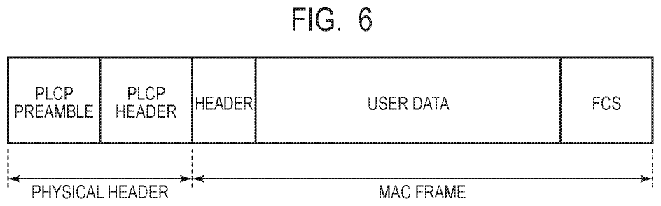

FIG. 6 is a diagram illustrating one example of a frame of wireless communication in the present example embodiment. As described above, the MAC frame includes a MAC header, user data, and a frame check sequence (FCS). The user data is so-called payload data, which has 2312 bytes at the maximum in IEEE 802.11.g or 257 bytes at the maximum in IEEE 802.15.4. The frame check sequence is data used for detecting an error and is represented as 4 bytes, for example. The MAC header includes information on frame control data, time required for transmitting a frame, a destination MAC address, a source MAC address, a sequence number of data to be transmitted, a fragment number, or the like. The physical header includes a PLCP header and a PLCP preamble and is added in the physical layer. The PLCP header includes information on a modulation scheme (transmission rate), a data length, or the like, and the PLCP preamble includes synchronization data and Start of Frame Delimiter (SFD) data.

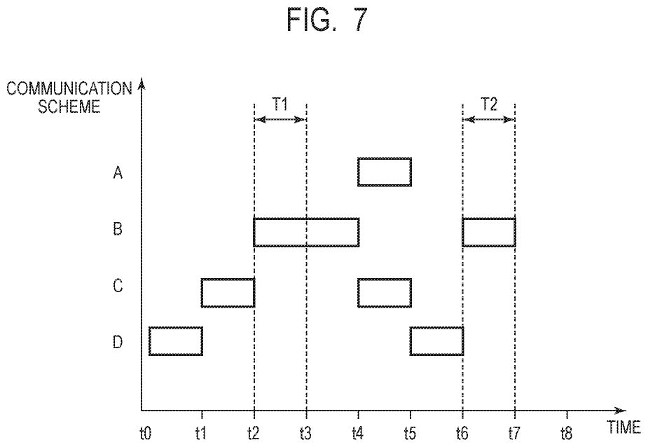

FIG. 7 is a conceptual diagram of a wireless communication method in the present example embodiment and illustrates the status of wireless communication according to each wireless communication scheme in the same frequency band. In FIG. 7, the horizontal axis represents time, and the vertical axis represents wireless communication schemes A to D. In the present example embodiment, band guarantee periods T (T1, T2, . . . ) are provided periodically. The band guarantee periods T are defined in advance, and communication according to one wireless communication scheme defined by schedule information is permitted and wireless communication according to other wireless communication schemes is prohibited during each band guarantee period T. The schedule information is transmitted in advance to the terminal devices 3A to 3D and the base stations 2A to 2D, and wireless communication in accordance with the schedule information is performed. The wireless communication method of FIG. 7 will be described below in detail.

In the period of the time t0 to t1, the terminal device 3D and the base station 2D perform wireless communication and, at the time t1, the terminal device 3C and the base station 2C start wireless communication. At the time t2, because the band guarantee period T1 starts, the terminal device 3C and the base station 2C stop the wireless communication. In the period of the time t2 to t3, that is, in the band guarantee period T1, only the terminal device 3B and the base station 2B that are predefined by schedule information can perform wireless communication. In the period of the time t3 to t4, although the band guarantee period T1 has elapsed, the terminal device 3B and the base station 2B may continue wireless communication unless collision occurs with wireless communication of other wireless communication schemes.

In the period of the time t4 to t5, an example in which there is a collision of wireless communication caused by two wireless communication schemes A and C is illustrated. In such a case, it will be difficult to successfully perform wireless communication, and an error of communication or a reduction in the communication rate may occur. At the time t5, the terminal device 3D and the base station 2D start wireless communication. At the time t6, because the band guarantee period T2 starts, the terminal device 3D and the base station 2D end the wireless communication. In the period of the time t6 to t7, that is, the band guarantee period T2, the terminal device 3B and the base station 2B defined by schedule information can perform wireless communication. Subsequently, the band guarantee period T occurs periodically in the same manner, and only the communication according to a wireless communication scheme in accordance with schedule information is permitted.

The band guarantee periods T are not necessarily required to occur at a constant cycle, and any predefined multiple periods may be employed. Further, it is desirable for the band guarantee period to have a length long enough to finish transfer of at least one data frame, which may be around 10 to 50 milliseconds, for example. Note that the frequency and the length of the band guarantee period T may be suitably set in accordance with the need for performing wireless communication with priority in any wireless communication scheme, the size of frame data, or the like. For example, when there is less need for performing wireless communication with priority, the frequency of the band guarantee periods T may be reduced, or the length of the band guarantee period T may be reduced.

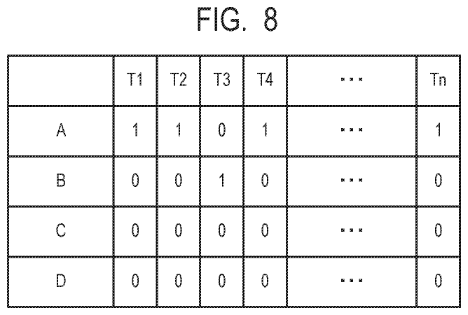

FIG. 8 is a diagram illustrating one example of schedule information in the present example embodiment, which illustrates which communication of the wireless communication schemes A to D is permitted in the band guarantee periods T1 to Tn. In schedule information, “1” represents that wireless communication is permitted, and “0” represents that wireless communication is prohibited. Only the wireless communication of the terminal device 3A and the base station 2A is permitted in the band guarantee periods T1, T2, and T4, and only the wireless communication of the terminal device 3B and the base station 2B is permitted in the band guarantee period T3. Schedule information may define permission and prohibition of wireless communication for the whole of the same frequency band, for example, the 2.4 GHz band or may define permission and prohibition of wireless communication for each non-overlapping channel in the 2.4 GHz band.

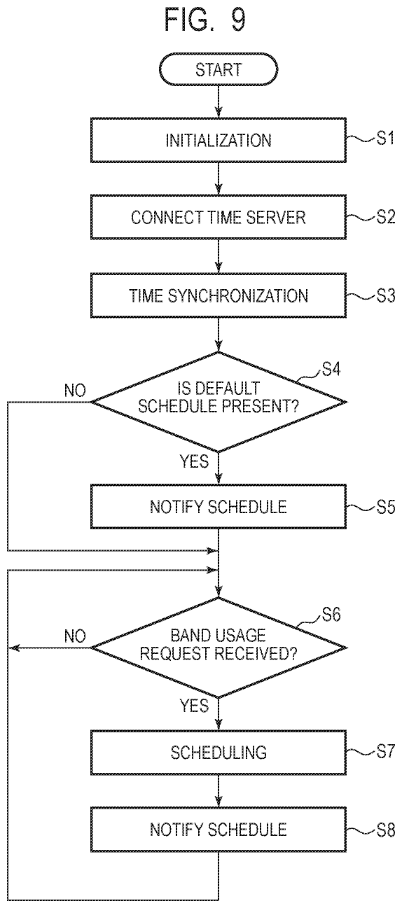

FIG. 9 is a flowchart illustrating the operation of the control apparatus in the present example embodiment. First, the control apparatus 1 executes a predetermined application program and initializes the control apparatus 1 (step S1). The control apparatus 1 accesses a time server through a network and acquires time information used as a reference (step S2). Further, the time information may be acquired from a Global Positioning System (GPS). After wireless communication between the base station 2 and the terminal device 3 is established, the control apparatus 1 synchronizes the time of the base station 2 and the time of the terminal device 3. Wireless communication between the base station 2 and the terminal device 3 is established by using static scan, dynamic scan, or the like. Static scan is performed by the terminal device 3 receiving a beacon from the base station 2, and dynamic scan is performed by the terminal device 3 transmitting a probe request to the base station 2. In response to establishment of connection between the base station 2 and the terminal device 3, the base station 2 transmits time information to the corresponding terminal device 3. In such a way, time synchronization of the control apparatus 1, the base station 2, and the terminal device 3 is completed (step S3).

Subsequently, the control apparatus 1 performs processing based on schedule information. If default schedule information is set (step S4, YES), the control apparatus 1 transmits the schedule information to the base station 2, and the base station 2 further transmits the schedule information to the corresponding terminal device 3 (step S5). The terminal device 3 performs wireless communication based on schedule information. For example, when the schedule information permits only the wireless communication according to the wireless communication scheme A in the band guarantee period, wireless communication according to other wireless communication schemes B to D is prohibited. That is, only the wireless communication by the terminal device 3A is permitted during the band guarantee period. If no schedule information is set (step S4, NO), the base station 2 and the terminal device 3 may perform wireless communication despite the band guarantee period. Note that if no schedule information is set, all the wireless communication of the wireless communication schemes A to D may be prohibited in a band guarantee period.

Subsequently, the control apparatus 1 determines whether or not there is a band usage request from the terminal device 3 (step S6). If there is no band usage request (step S6, NO), the control apparatus 1 waits until a band usage request is issued. If there is a band usage request from the terminal device 3 (step S6, YES), the control apparatus 1 newly sets schedule information in response to the band usage request (step S7). For example, once the terminal device 3A transmits a band usage request to the corresponding base station 2A, the base station 2A further transfers the band usage request to the control apparatus 1. A band usage request may include information on the number of times or the frequency of required band guarantee periods, the size of transmission data, the priority, or the like, for example. The control apparatus 1 sets one or a plurality of band guarantee periods permitted to the terminal device 3A in accordance with the band usage request. Further, when band usage requests are issued from a plurality of terminal devices 3, the control apparatus allocates band guarantee periods to each of the plurality of terminal devices 3 based on information on the priority or the like on the band usage request. That is, the length or the frequency of band guarantee periods can be allocated to each of the terminal devices 3 in accordance with the priority. For example, when the ratio of priority between the terminal devices 3A and 3B is 80% and 20%, the ratio of the length or the frequency of the band guarantee period permitted for the terminal devices 3A and 3B may be defined to be 80% and 20%.

The control apparatus 1 transmits schedule information to the terminal device 3 via the base station 2, and the terminal device 3 performs wireless communication in accordance with the schedule information (step S8). Then, if a band usage request is issued (step S6, YES) and when new schedule information is set by the control apparatus 1, the terminal device 3 performs wireless communication in accordance with the new schedule information. Note that, when the band guarantee periods whose number of times or length is defined in schedule information end and no new schedule information is set, the terminal device 3 is unable to perform wireless communication during a band guarantee period. Note that, when no schedule information is set, the band guarantee period may be eliminated, and communication of the terminal device 3 may be permitted.

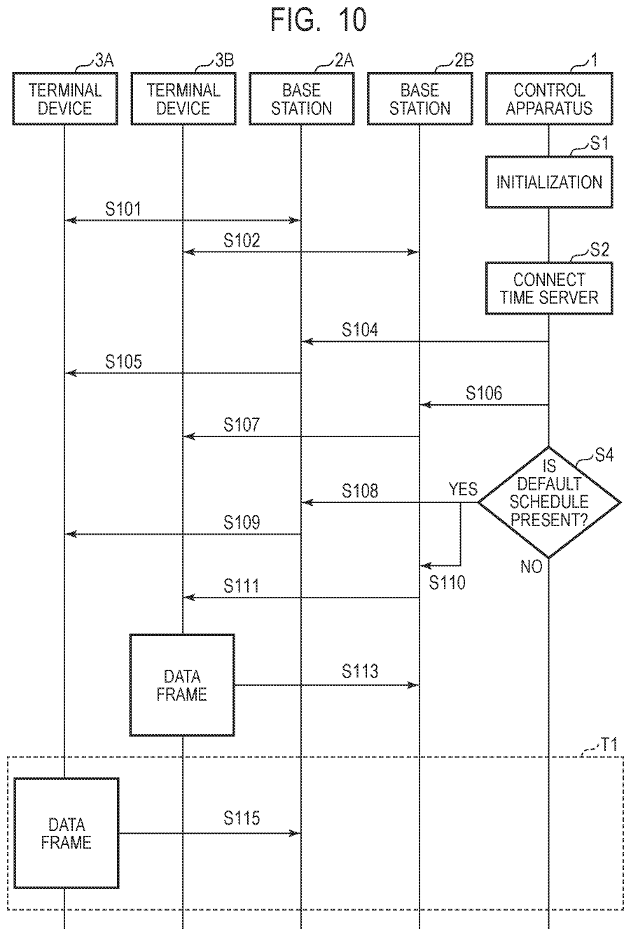

FIG. 10 is a sequence chart of the wireless communication system in the present example embodiment. For simplified illustration, the terminals devices 3A and 3B corresponding to the wireless communication schemes A and B, the base stations 2A and 2B corresponding to the wireless communication schemes A and B, and the control apparatus 1 are illustrated here.

First, the control apparatus 1 executes a predetermined application program and initializes the control apparatus 1 (step S1). The terminal device 3A transmits a probe request to the base station 2A, and wireless communication between the terminal device 3A and the base station 2A establishes (step S101). Similarly, wireless communication between the terminal device 3B and the base station 2B establishes (step S102). The control apparatus 1 connects to a time server to acquire time information used as a reference (step S2) and transmits the time information to the base stations 2A and 2B (steps S104 and S106). The base stations 2A and 2B further transfer time information to the terminal devices 3A and 3B (steps S105 and S107). Thereby, respective timers 209 of the base stations 2A and 2B and respective timers 309 of the terminal devices 3A and 3B start timing in synchronization with the reference time in the control apparatus 1.

If default schedule information is set (step S4, YES), the control apparatus 1 transmits the schedule information to the base stations 2A and 2B (steps S108 and S110). The base stations 2A and 2B transfer the schedule information to the terminal devices 3A and 3B (steps S109 and S111). Then, the terminal devices 3A and 3B perform wireless communication in accordance with schedule information. Outside band guarantee periods, for example, the terminal device 3B performs carrier sense, confirms that a band is not used, and then transfers data frame to the base station 2B (step S113). In the band guarantee period T1, only the wireless communication scheme defined by the schedule information is permitted. For example, when the wireless communication scheme A is defined, only the terminal device 3A can transmit data frame to the base station 2A in the band guarantee period T1 (step S115). After the completion of the band guarantee period T1, the terminal device 3A performs carrier sense, confirms that there is no contention with other wireless communication schemes, and then transmits data frame.

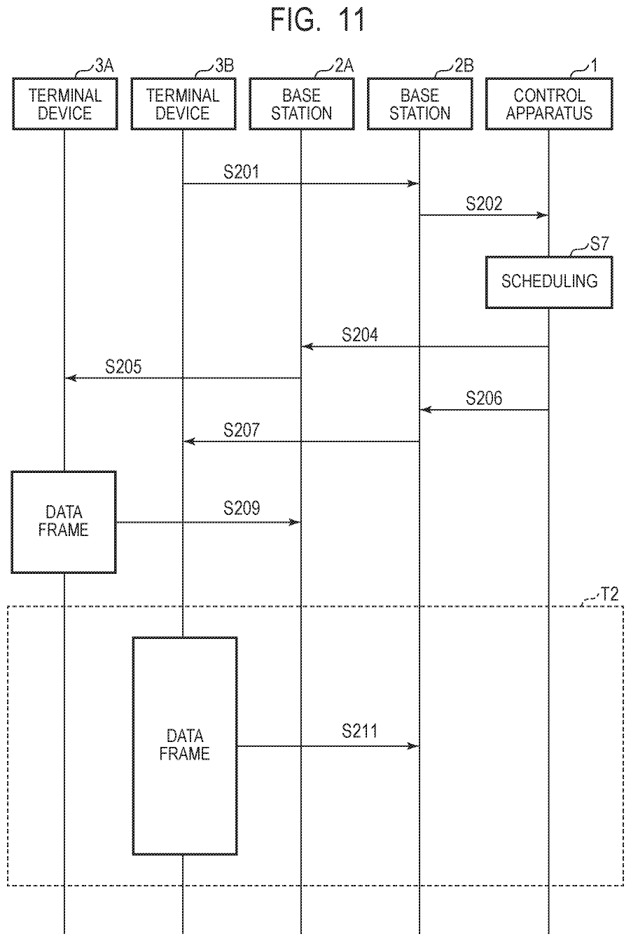

In FIG. 11, in response to the terminal device 3B transmitting a band usage request to the base station 2B (step S201), the base station 2B further transfers the band usage request to the control apparatus 1 (step S202). The control apparatus 1 sets new schedule information based on the band usage request (step S7) and transmits the new schedule information to the base stations 2A and 2B (steps S204 and S206). The base stations 2A and 2B further transfer the schedule information to the terminal devices 3A and 3B (steps S205 and S207). While the terminal device 3A may transmit data frame to the base station 2A outside band guarantee periods, the terminal device 3A ends transmission of data frame in response to the start of the band guarantee period T2 (step S209). In the band guarantee period T2, only the terminal device 3B permitted by the schedule information can transmit data frame (step S211). After the band guarantee period T2 ends, the terminal device 3B performs carrier sense, confirms that there is no contention with other wireless communication schemes, and then can continue transmission of data frame.

As described above, according to the present example embodiment, in a plurality of wireless communication schemes that share the same frequency band, it is possible to avoid collision of wireless communication by determining a wireless communication scheme permitted for wireless communication in a predefined band guarantee period and permitting only the wireless communication according to the wireless communication. Thereby, frame data from a terminal device having high priority can be reliably transmitted.

### Second Example Embodiment

While the wireless communication system in the example embodiment described above defines a wireless communication scheme for each band guarantee period, one band guarantee period may be divided into a plurality of periods, and a wireless communication scheme permitted for wireless communication may be defined in each period. The wireless communication system in the present example embodiment will be described mainly for a configuration different from the wireless communication system in the first example embodiment.

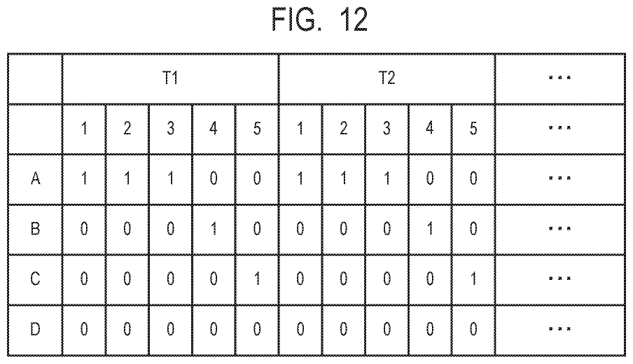

FIG. 12 is a diagram illustrating one example of schedule information in the present example embodiment. The band guarantee periods T1 and T2 are divided into five divided periods T1_1 to T1_5 and T2_1 to T2_5, respectively. When band usage requests are issued from a plurality of terminal devices 3, the control apparatus 1 can set wireless communication schemes for respective divided periods in accordance with the priority of the band usage requests. For example, it is assumed that band usage requests are issued from the terminals devices 3A, 3B, and 3C, and respective ratios of priority are 60%, 20%, and 20%. In this case, the control apparatus 1 can allocate the divided periods T1_1 to T1_3 to the wireless communication scheme A, allocate the divided period T1_4 to the wireless communication scheme B, and then allocate the divided period T1_5 to the wireless communication scheme C, for example, in accordance with the ratios of priority.

According to the present example embodiment, it is possible to perform a finer scheduling by dividing one band guarantee period and allocating the divided periods to wireless communication schemes. Further, allocation may be determined at different ratios between respective band guarantee periods. For example, allocation may be determined at different ratios between the odd-numbered band guarantee periods T1, T3, T5, . . . and the even-numbered band guarantee periods T2, T4, T6, . . . . Furthermore, a different setting may be applied to every predetermined multiple of band guarantee periods. For example, the setting may be different for the band guarantee periods T3, T6, T9, . . . and the band guarantee periods T1 to T2, T4 to T5, and T7 to T8.

### Third Example Embodiment

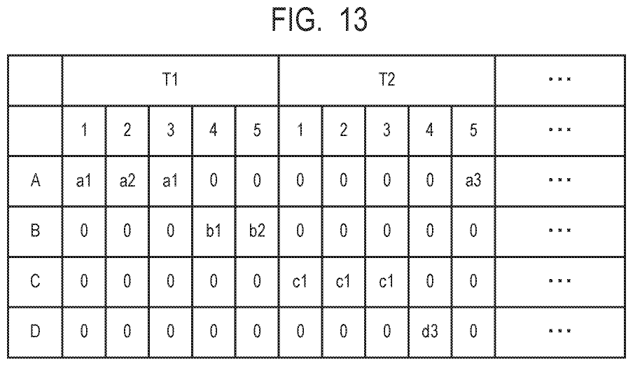

FIG. 13 is a diagram illustrating one example of schedule information in the present example embodiment. While the control apparatus 1 in each of the first and second example embodiments determines a wireless communication scheme permitted for wireless communication during a band guarantee period, the control apparatus 1 in the present example embodiment may further determine a terminal device in addition to a wireless communication scheme. In the schedule information illustrated in FIG. 13, references “a1, a2, a3, b1, b2, c1, d3, . . . ” each denote identification information of a terminal device that can perform wireless communication during a band guarantee period. For example, in the band guarantee period T1, wireless communication of the terminal device a1 of the wireless communication scheme A is permitted in each of the divided periods T1_1 and T1_3 of the band guarantee period T1, and wireless communication of the terminal device a2 of the wireless communication scheme A is permitted in the divided period T1_2. Further, wireless communication of the terminal device b1 of the wireless communication scheme B is permitted in the divided period T1_4, and wireless communication of the terminal device b2 of the wireless communication scheme B is permitted in the divided period T1_5.

As described above, according to the present example embodiment, it is possible to avoid contention of wireless communication between terminal devices in advance by determining a wireless communication scheme and a terminal device during a band guarantee period.

### Fourth Example Embodiment

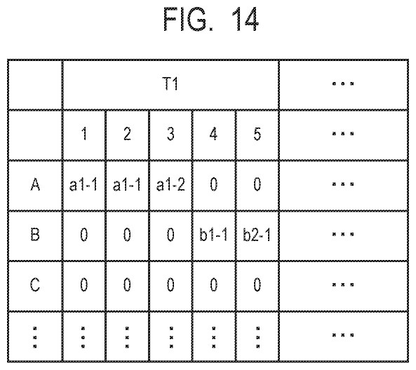

FIG. 14 is a diagram illustrating one example of schedule information in the present example embodiment. In the present example embodiment, the control apparatus 1 can further determine a process flow to permit wireless communication in a band guarantee period. That is, schedule information may be set in accordance with the priority of a communication terminal and a process flow. The schedule information illustrated in FIG. 14 illustrates a terminal device permitted to perform wireless communication in a band guarantee period and a process flow. References “a1-1” and “a1-2” each denote identification information of a process flow in the terminal device a1 of the wireless communication scheme A, and “b1-1” and “b2-1” each denote identification information of a process flow in the terminal devices b1 and b2 of the wireless communication scheme B. Here, a process flow may be robot control, voice communication, file download, or the like. In robot control, since a real-time process is required, it is desirable to allocate a short period to each band guarantee period. For example, the terminal device a1 prioritizes wireless communication of the process flow a1-2 of robot control in a short divided period T1_3 every 100 milliseconds. In such a way, for a process flow such as robot control in which real-time processing is required, it is possible to avoid contention with wireless communication of other process flows by permitting wireless communication with high priority for each band guarantee period.

On the other hand, real-time processing is less required for voice communication than for robot control. Thus, the priority of voice communication may be set to be lower than the priority of robot control. For example, as long as no contention with wireless communication of robot control occurs, relatively longer band guarantee periods each having 1 second may be allocated to voice communication. Further, since real-time processing is less required for file download, it is desirable to perform wireless communication in a time range in which no other wireless communication is performed, without allocating a band guarantee period.

As described above according to the present example embodiment, schedule information can be set based on a communication terminal and a process flow in addition to a wireless communication scheme. This enables wireless communication in accordance with characteristics of an application program.

### Fifth Example Embodiment

The present invention is not limited to the example embodiments described above and can be appropriately changed within the scope not departing from the spirit of the present invention. For example, instead of setting schedule information in accordance with a band usage request by the terminal device 3, the control apparatus 1 may set schedule information. For example, the control apparatus 1 determines the operation status of the entire wireless communication system and may permit a use of a band guarantee period for a wireless communication scheme that is necessary for wireless communication with priority. Further, schedule information may be set in any one of the base stations 2 or a plurality of base stations 2 instead of the control apparatus 1. Furthermore, schedule information may be set for each non-overlapping channel in the same frequency band. With a single frequency band being divided into a plurality of bands (channels), limited frequency resource can be effectively utilized.

### Sixth Example Embodiment

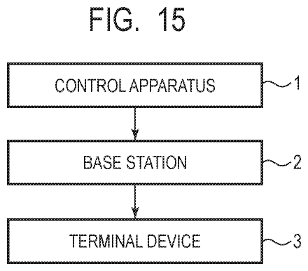

FIG. 15 is a block diagram of a wireless communication system in the present example embodiment. The wireless communication system in the present example embodiment includes the control apparatus 1, the base station 2, and the terminal device 3. The wireless communication system may perform wireless communication according to a plurality of wireless communication schemes that share the same frequency band. The control apparatus determines the wireless communication scheme permitted for wireless communication for each of the plurality of predefined periods. Furthermore, the control apparatus causes the terminal device to perform only the wireless communication based on the determined wireless communication scheme during the period.

According to the present example embodiment, in a wireless communication system using a plurality of wireless communication schemes that share the same frequency band, it is possible to reliably perform wireless communication having high priority by determining a wireless communication scheme permitted for wireless communication in each of the plurality of predefined periods.

The whole or part of the example embodiments disclosed above can be described as, but not limited to, the following supplementary notes.

(Supplementary Note 1)

A wireless communication system including a plurality of base stations and a plurality of terminal devices capable of performing wireless communication by using a plurality of wireless communication schemes that share the same frequency band, the wireless communication system further comprising:

a control apparatus that, in each of a plurality of predefined periods, determines a wireless communication scheme permitted for wireless communication and causes each of the terminal devices to perform only wireless communication based on the determined wireless communication scheme during the periods.

(Supplementary Note 2)

The wireless communication system according to supplementary note 1, wherein the control apparatus transmits schedule information that defines wireless communication to be permitted during the periods to the plurality of terminal devices, and the plurality of terminal devices perform wireless communication based on the schedule information.

(Supplementary Note 3)

The wireless communication system according to supplementary note 1 or 2, wherein in response to receiving an inquiry as to whether or not wireless communication based on the determined wireless communication scheme is permitted, the control apparatus determines whether or not to permit the wireless communication based on priority allocated to the terminal devices.

(Supplementary Note 4)

The wireless communication system according to any one of supplementary notes 1 to 3, wherein the control apparatus changes wireless communication to be permitted during the periods on a cycle basis or on multiple cycles basis.

(Supplementary Note 5)

The wireless communication system according to supplementary note 3, wherein based on the priority of the terminal devices, the control apparatus determines a frequency of the periods in which wireless communication is permitted by the terminal devices.

(Supplementary Note 6)

The wireless communication system according to any one of supplementary notes 1 to 5, wherein each of the plurality of terminal devices determines whether or not to permit wireless communication in the periods based on timers synchronized with each other.

(Supplementary Note 7)

The wireless communication system according to any one of supplementary notes 1 to 6, wherein the control apparatus is provided in a server that manages the plurality of base stations.

(Supplementary Note 8)

The wireless communication system according to any one of supplementary notes 1 to 6, wherein the control apparatus is provided in at least any one of the plurality of base stations.

(Supplementary Note 9)

The wireless communication system according to any one of supplementary notes 1 to 8, wherein the periods are defined for respective channels that do not overlap each other in the same frequency band.

(Supplementary Note 10)

The wireless communication system according to any one of supplementary notes 1 to 9, wherein each of the periods includes a plurality of divided periods, and the control apparatus determines the wireless communication scheme permitted for wireless communication for each of the plurality of divided periods and causes each of the terminal devices to perform only wireless communication based on the determined wireless communication scheme in the divided periods.

(Supplementary Note 11)

The wireless communication system according to any one of supplementary notes 1 to 10, wherein the control apparatus further determines the terminal devices permitted for wireless communication in the periods.

(Supplementary Note 12)

The wireless communication system according to any one of supplementary notes 1 to 11, wherein the control apparatus further determines a process flow permitted for wireless communication in the periods.

(Supplementary Note 13)

A control apparatus that controls a plurality of base stations and a plurality of terminal devices capable of performing wireless communication by using a plurality of wireless communication schemes that share the same frequency band,

wherein, in each of a plurality of predefined periods, the control apparatus determines a wireless communication scheme permitted for wireless communication and causes each of the terminal devices to perform only wireless communication based on the determined wireless communication scheme during the periods.

(Supplementary Note 14)

A base station used in a wireless communication system comprising a plurality of terminal devices and a plurality of base stations capable of performing wireless communication by using a plurality of wireless communication schemes that share the same frequency band and a control apparatus,

wherein in each of a plurality of predefined periods, a wireless communication scheme permitted for wireless communication is determined, and signals that cause each of the terminal devices to perform only wireless communication based on the determined wireless communication scheme during the periods are transmitted from the control apparatus to the plurality of terminal devices.

(Supplementary Note 15)

A terminal device used in a wireless communication system comprising a plurality of base stations and a plurality of terminal devices capable of performing wireless communication by using a plurality of wireless communication schemes that share the same frequency band and a control apparatus,

wherein in each of a plurality of predefined periods, a wireless communication scheme permitted for wireless communication is determined, and the terminal device is controlled based on a signal that causes the terminal device to perform only wireless communication based on the determined wireless communication scheme during the periods.

(Supplementary Note 16)

A control method of a control apparatus that controls a plurality of base stations and a plurality of terminal devices capable of performing wireless communication by using a plurality of wireless communication schemes that share the same frequency band, the control method comprising a step of:

in each of a plurality of predefined periods, determining a wireless communication scheme permitted for wireless communication and causing each of the terminal devices to perform only wireless communication based on the determined wireless communication scheme during the periods.

(Supplementary Note 17)

A control method of a control apparatus that controls a plurality of base stations and a plurality of terminal devices capable of performing wireless communication by using a plurality of wireless communication schemes that share the same frequency band, the control method comprising a step of:

in each of a plurality of predefined periods, determining a wireless communication scheme permitted for wireless communication and causing each of the terminal devices to perform only wireless communication based on the determined wireless communication scheme during the periods.

(Supplementary Note 18)

A control method of a base station used in a wireless communication system comprising a plurality of terminal devices and a plurality of base stations capable of performing wireless communication by using a plurality of wireless communication schemes that share the same frequency band and a control apparatus, the control method comprising a step of:

in each of a plurality of predefined periods, determining a wireless communication scheme permitted for wireless communication and transmitting, from the control apparatus to the plurality of terminal devices, signals that cause each of the terminal devices to perform only wireless communication based on the determined wireless communication scheme during the periods.

(Supplementary Note 19)

A control method of a terminal device used in a wireless communication system comprising a plurality of base stations and a plurality of terminal devices capable of performing wireless communication by using a plurality of wireless communication schemes that share the same frequency band and a control apparatus, the control method comprising a step of:

in each of a plurality of predefined periods, determining a wireless communication scheme permitted for wireless communication and controlling the terminal device based on a signal that causes the terminal device to perform only wireless communication based on the determined wireless communication scheme during the periods.

(Supplementary Note 20)

A storage medium storing a program that causes a computer to perform a control method of a control apparatus that controls a plurality of base stations and a plurality of terminal devices capable of performing wireless communication by using a plurality of wireless communication schemes that share the same frequency band, the control method comprising a step of:

in each of a plurality of predefined periods, determining a wireless communication scheme permitted for wireless communication and causing each of the terminal devices to perform only wireless communication based on the determined wireless communication scheme during the periods.

(Supplementary Note 21)

A program storage medium storing a program that causes a computer to perform a control method of a control apparatus that controls a plurality of base stations and a plurality of terminal devices capable of performing wireless communication by using a plurality of wireless communication schemes that share the same frequency band, the control method comprising a step of:

in each of a plurality of predefined periods, determining a wireless communication scheme permitted for wireless communication and causing each of the terminal devices to perform only wireless communication based on the determined wireless communication scheme during the periods.

(Supplementary Note 22)

A storage medium storing a program that causes a computer to perform a control method of a base station used in a wireless communication system comprising a plurality of terminal devices and a plurality of base stations capable of performing wireless communication by using a plurality of wireless communication schemes that share the same frequency band and a control apparatus, the control method comprising a step of:

in each of a plurality of predefined periods, determining a wireless communication scheme permitted for wireless communication and transmitting, from the control apparatus to the plurality of terminal devices, signals that cause the terminal devices to perform only wireless communication based on the determined wireless communication scheme during the periods.

(Supplementary Note 23)

A storage medium storing a program that causes a computer to perform a control method of a terminal device used in a wireless communication system comprising a plurality of base stations and a plurality of terminal devices capable of performing wireless communication by using a plurality of wireless communication schemes that share the same frequency band and a control apparatus, the control method comprising a step of:

in each of a plurality of predefined periods, determining a wireless communication scheme permitted for wireless communication and controlling the terminal device based on a signal that causes the terminal device to perform only wireless communication based on the determined wireless communication scheme during the periods.

This application is based upon and claims the benefit of priority from Japanese Patent Application No. 2017-057127, filed on Mar. 23, 2017, the disclosure of which is incorporated herein in its entirety by reference.

1. A control apparatus that controls a plurality of base stations and a plurality of terminal devices configured to perform wireless communication by using a plurality of wireless communication schemes that share the same frequency band, comprising:
at least one memory configured to store instructions; and
at least one processor configured to execute the instructions to:
in each of a plurality of predefined periods, determines a wireless communication scheme permitted for wireless communication, and
causes each of the terminal devices to perform only wireless communication based on the determined wireless communication scheme during the periods.

2. The control apparatus according to claim 1, wherein the control apparatus transmits schedule information that defines wireless communication to be permitted during the periods to the plurality of terminal devices, and
the plurality of terminal devices perform wireless communication based on the schedule information.

3. The control apparatus according to claim 1, wherein in response to receiving an inquiry as to whether or not wireless communication based on the determined wireless communication scheme is permitted, the control apparatus determines whether or not to permit the wireless communication based on priority allocated to the terminal devices.

4. The control apparatus according to claim 1, wherein the control apparatus changes wireless communication to be permitted during the periods at least one of on a cycle basis and on multiple cycles basis.

5. The control apparatus according to claim 3, wherein based on the priority of the terminal devices, the control apparatus determines a frequency of the periods in which wireless communication is permitted by the terminal devices.

6. The control apparatus according to claim 1, wherein each of the plurality of terminal devices determines whether or not to permit wireless communication in the periods based on timers synchronized with each other.

7. The control apparatus according to claim 1, wherein the control apparatus is provided in a server that manages the plurality of base stations.

8. The control apparatus according to claim 1, wherein the control apparatus is provided in at least any one of the plurality of base stations.

9. The control apparatus according to claim 1, wherein the periods are defined for respective channels that do not overlap each other in the same frequency band.

10. The control apparatus according to claim 1, wherein each of the periods includes a plurality of divided periods, and the control apparatus determines the wireless communication scheme permitted for wireless communication for each of the plurality of divided periods and causes each of the terminal devices to perform only wireless communication based on the determined wireless communication scheme in the divided periods.

11. The control apparatus according to claim 1, wherein the control apparatus further determines the terminal devices permitted for wireless communication in the periods.

12. The control apparatus according to claim 1, wherein the control apparatus further determines a process flow permitted for wireless communication in the periods.

13.-15. (canceled)

16. A control method of a control apparatus that controls a plurality of base stations and a plurality of terminal devices capable of performing wireless communication by using a plurality of wireless communication schemes that share the same frequency band, the control method comprising a step of:
in each of a plurality of predefined periods, determining a wireless communication scheme permitted for wireless communication and causing each of the terminal devices to perform only wireless communication based on the determined wireless communication scheme during the periods.

17.-19. (canceled)

20. A non-transitory storage medium storing a program that causes a computer to perform a control method of a control apparatus that controls a plurality of base stations and a plurality of terminal devices capable of performing wireless communication by using a plurality of wireless communication schemes that share the same frequency band, the control method comprising a step of:
in each of a plurality of predefined periods, determining a wireless communication scheme permitted for wireless communication and causing each of the terminal devices to perform only wireless communication based on the determined wireless communication scheme during the periods.

21.-23. (canceled)

24. The control apparatus according to claim 2, wherein in response to receiving an inquiry as to whether or not wireless communication based on the determined wireless communication scheme is permitted, the control apparatus determines whether or not to permit the wireless communication based on priority allocated to the terminal devices.

25. The control apparatus according to claim 2, wherein the control apparatus changes wireless communication to be permitted during the periods at least one of on a cycle basis and on multiple cycle basis.

26. The control apparatus according to claim 3, wherein the control apparatus changes wireless communication to be permitted during the periods at least one of on a cycle basis and on multiple cycle basis.

27. The control apparatus according to claim 2, wherein each of the plurality of terminal devices determines whether or not to permit wireless communication in the periods based on timers synchronized with each other.

28. The control apparatus according to claim 3, wherein each of the plurality of terminal devices determines whether or not to permit wireless communication in the periods based on timers synchronized with each other.

29. The control apparatus according to claim 4, wherein each of the plurality of terminal devices determines whether or not to permit wireless communication in the periods based on timers synchronized with each other.
